(19) United States
(12) Patent Application Publication
(10) Pub. No.: US 2017/0226781 A1
(43) Pub. Date: Aug. 10, 2017

(54) Bin Latch System

(71) Applicant: Centrix Aero, LLC, Kent, WA (US)

(72) Inventor: Andres Hernandez, Yorba Linda, CA (US)

(73) Assignee: Centrix Aero, LLC, Kent, WA (US)

(21) Appl. No.: 15/413,040

(22) Filed: Jan. 23, 2017

Related U.S. Application Data
(60) Provisional application No. 62/286,261, filed on Jan. 22, 2016.
(60) Provisional application No. 62/286,311, filed on Jan. 22, 2016.
(60) Provisional application No. 62/378,199, filed on Aug. 22, 2016.

(51) Int. Cl. E05C 9/04; B64D 11/00; E05C 1/12; E05B 63/20; E05C 9/18; E05C 9/22

(52) U.S. Cl. CPC E05C 9/042; E05C 9/1808; E05C 9/22; E05C 9/1825; E05C 1/12; E05B 63/20; B64D 11/003

(57) ABSTRACT

A bin latch system. A bin latch mechanism that has been designed with weight, number of components, simplicity of operation and installation as main design drivers. The bin latch utilizes spring loaded rods that are ‘pulled’ to release the locking subassemblies. The rods lock two sets of interlocking housings in place. Due to the nature of the rod actuator, the design is binary in nature and needs both sets of interlocking housings to be secured before the interface handle can go to ‘full close’ position. Additionally, there is no rigging necessary at install. Once the assembly is in secured in place, it is ready to be operated.

### CROSS-REFERENCE TO RELATED APPLICATION

The application claims the benefit under 35 U.S.C. §119(e) of Provisional Application Ser. No. 62/286,261, entitled “Bin Latch System” filed on Jan. 22, 2016, the subject matter of which is incorporated herein by reference in its entirety, and Provisional Application Ser. No. 62/286,311, entitled “Bin Latch System” filed on Jan. 22, 2016, and Provisional Application Ser. No. 62/378,199, entitled “Improved Bin Latch System With Interchangeable End Pieces” filed on Aug. 22, 2016, the subject matter of which is incorporated herein by reference in its entirety.

### TECHNICAL FIELD

This description relates generally to mechanical latching systems and more specifically to mechanical latching systems used in aircraft storage compartments.

### BACKGROUND

Overhead storage/luggage bins are typically used in passenger aircrafts to store passenger baggage and various other items. The bins are mounted on the ceiling above the passenger seats with a latched door cover to prevent items with the bins from falling out. It is necessary that the bin latch is easy to open/close and also robust enough to remain closed even under some mechanical stress. For example, when an aircraft meets distributing air during flight, the luggage may slide inside the bin and exert significant mechanical impact to the door cover. It is very desirable that the door cover could remain closed to prevent any passenger injury caused by falling luggage.

Aircraft bin latch systems are typically made up of multiple parts that are installed with the bin, and take up assembly time on the main aircraft production line. Accordingly a bin latch system that may be installed as a single part would be desirable.

### SUMMARY OF THE INVENTION

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present disclosure provides a bin latch mechanism that has been configured with weight, number of components, simplicity of operation and installation.

The disclosed latch system utilizes spring loaded rods that are ‘pulled’ to release the locking sub-assemblies. The rods lock two sets of interlocking housings in place. Due to the nature of the rod actuator, the design is binary in nature and needs both sets of interlocking housings to be secured before the interface handle can go to ‘full close’ position.

The bin latch actuator transfers rotation of the human interface (or actuator interface, a handle) into push/pull action in the actuating mechanism, and utilizes the connecting members as push/pull rods. Consequently, the connecting members have a reduced size and weight, and are not subject to mechanical properties variations if/when their length increase. In some embodiments, the remote latches are a combination of a few components that interlock with each other utilizing this push/pull motion. A safety device may be included on each remote latch to prevent losing of the system when the remote latches are disengaged. Additionally, an emergency release mechanism may be incorporated in the remote latches to override the overall mechanism in case of sub-structure damage for example.

Additionally, there is no rigging necessary at install. Once the assembly is in secured in place, it is ready to be operated.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a bin latch system installed in a storage bin.

FIG. 2 shows a first embodiment of a bin latch system.

FIG. 3 shows an actuator in a closed position viewed from a human interface.

FIG. 4 shows an actuator in an open position viewed from a human interface.

FIG. 5 shows a top view and a front view of an actuator of the bin latch.

FIG. 6 shows a component view of an actuator of the bin latch in a closed position.

FIG. 7 shows a component view of an actuator of the bin latch in an open position.

FIG. 8 shows an alternative embodiment of the actuator.

FIG. 9 shows a first exemplary remote latch in a disengaged position.

FIG. 10 shows the first exemplary remote latch in a closed position.

FIG. 11 shows a prospective view of a second exemplary remote latch in a closed position.

FIG. 12 shows a front view of the second exemplary remote latch in the closed position.

FIG. 13 shows a sectional view of the second exemplary remote latch in the closed position.

FIG. 14 shows a prospective view of the second exemplary remote latch in an open position.

FIG. 15 shows a front view of the second exemplary remote latch in the open position.

FIG. 16 shows a sectional view of the second exemplary remote latch in the open position.

FIG. 17 shows a prospective view of the second exemplary remote latch in a disengaged position.

FIG. 18 shows a front view of the second exemplary remote latch in the disengaged position.

FIG. 19 shows a sectional view of the second exemplary remote latch in the disengaged position.

FIG. 20 shows a prospective view of the second exemplary remote latch in a released position under emergency operation.

FIG. 21 shows a front view of the second exemplary remote latch in the released position under emergency operation.

FIG. 22 shows a sectional view of the second exemplary remote latch in the released position under emergency operation.

FIG. 23 shows a prospective view of the second exemplary remote latch in a disengaged position under emergency operation.

FIG. 24 shows a front view of the second exemplary remote latch in the disengaged position under emergency operation.

FIG. 25 shows a sectional view of the second exemplary remote latch in the disengaged position under emergency operation.

FIG. 26 shows a second embodiment of a bin latch system including an actuator with interchangeable end pieces, or latches.

FIG. 27 shows the second embodiment of a bin latch system installed in a storage bin.

FIG. 28 shows a close-up view of the actuator and the latch.

FIG. 29 shows an open position of the second embodiment of a bin latch system.

FIG. 30 shows a closed position of the second embodiment of a bin latch system.

FIGS. 31-33 show the actuator assembly and nomenclature.

FIGS. 34-35 show assembly and nomenclature of the latch and substructure.

FIGS. 36-37 show a close-up view of the open and close position of the latch.

Like reference numerals are used to designate like parts in the accompanying drawing.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a bin latch system. Although the present examples are described and illustrated herein as being implemented in an aircraft system, the system described is provided as an example and not a limitation. As those skilled in the art will appreciate, the present examples are suitable for application in a variety of different types of bin system.

Conventional commercial aircraft stowage bin latch assemblies and mechanisms of the like. These Bin Latch Systems are normally comprised of a stowage bin centrally located actuating mechanism (human interface) connected to remote latching devices located in each one of the stowage bin end panels via tubular connecting members. As aircrafts main cabins grow, these stowage bins grow as well. As the primary technology used to connect the actuating mechanism with the remote latches is based on the rotation of the connecting member (tube/rod/link), a significant amount of assembly time is needed to “clock” the remote latch to the connecting member to the actuating mechanism. To reduce this “clocking” the connecting members have the tendency to grow in diameter to reduce their torsional flexibility.

The invention is directed to multiple contact point latch actuators; latch assemblies comprising said latch actuators in addition to latch strikes and latch units, the latter of which are preferably interlocking to create a constrained mechanical fit between the components thereof, said actuators and latch assemblies being particularly adapted for hinged structures such as stowage bins; and methods for operating latch actuators and latch assemblies, as well as for securing and un-securing hinged structures comprising latch assemblies.

Embodiments of the invention directed to latch actuators comprise actuator housings rotationally securing, either directly or through an associated structure, cylindrical sleeves. Each such sleeve, in turn, defines a pair of mirror image slots, which are preferably helical or pseudo-helical, the sleeve being rotationally retained by the actuator housing, either directly or through an associated structure. An actuator interface, preferably in the form of a lever arm, is pivotally mounted to the actuator housing, adjacent to the sleeve, and is operatively linked to the sleeve to cause bi-directional rotation of the same during reciprocation of the actuator interface. Alternatively, the actuator interface is directly mounted to or extends from the sleeve.

Linked to the sleeve are a pair of latch rods, each having a proximal portion terminating at a proximal end and a distal portion terminating at a distal end, wherein each latch rod end and at least part of each latch rod proximal portion is disposed within the sleeve, and a protrusion, sized to fit within a helical slot, extends from each latch rod proximal portion and into a corresponding helical slot of the sleeve. Preferably a biasing member is located axially between the proximal ends of the latch rods to create a distally directed vectored force in each latch rod (i.e., the latch rods are biased to extend from the latch housing towards their respective distal ends). The distal ends of the latch rods include a strike member (or, as will be described below, a connection interface).

In many embodiments, the distal ends of the latch rods include a connection interface as opposed to a latch interface to enable linkage of extension rods thereto. In this manner, a common latch assembly can be used for a variety of specific application environments wherein the length of the rods can be modified by using differing length extension rods.

Latch assembly embodiments, as mentioned above, comprise a latch actuator and a pair of latch assemblies, each of which includes a strike housing and a receiver. The strike housing defines an orifice through which the distal end of a latch rod may pass, which itself comprises a strike member. Additionally, the strike housing has at least one restraint means that functions, in combination with complementary restraint means on the receiver, to arrest relative motion (whether in a single axis or multiple axes) between the two parts when the same are in a mated arrangement.

With respect to the axes of relative motion and restraint, the following convention is used herein: the direction of preferred mating between the strike housing and the receiver occurs in the Y axis and the latch rod reciprocation occurs in the Z axis. As such, the latch interface of a latch rod functions to prevent movement of the receiver relative to the latch housing in at least the positive Y direction (“+Y”) when the two are in a mated arrangement. This is true in both conventional latch-strike arrangements and the various invention embodiments. However, in preferred latch assembly embodiments, at least one landing portion extends from the strike housing face (obverse side) in the positive Z (“+Z”) direction. A seat portion of the receiver presenting to the negative Y side (“−Y”) thereof is sized to contact each landing portion, thereby obviating the need for the strike member to prevent relative movement between the strike housing and the receiver in both Y directions (the landing-seat interference prevents movement of the receiver in the −Y direction).

To address relative movement between the two latch unit components in strike housing (movement in the −z direction is prevented by contact between the strike housing obverse side and the receiver obverse side), at least one return, displaced from the strike housing obverse side, extends in the +Y direction into a slot defined by the receiver or a groove formed in the receiver reverse side, wherein the slot or groove has a major axis congruent with the Y axis and at least one surface presenting to the +Z side. When this return occupies a complementary slot or groove of the receiver when the two components are in a mated arrangement, movement of the receiver in the +Z direction is thereby prevented.

In many embodiments, at least one return extends from at least one landing wherein the at least one return is received by a complimentary slot formed in the reverse side of the receiver.

As a consequence of these complimentary restraints means, a non-strike dependent interlock is established in all directions except for the +Y direction, which is modulated by the extension or retraction of the strike interface.

For purposes of this patent, the terms “area”, “boundary”, “part”, “portion”, “surface”, “zone”, and their synonyms, equivalents and plural forms, as may be used herein and by way of example, are intended to provide descriptive references or landmarks with respect to the article and/or process being described. These and similar or equivalent terms are not intended, nor should be inferred, to delimit or define per se elements of the referenced article and/or process, unless specifically stated as such or facially clear from the several drawings and/or the context in which the term(s) is/are used.

Current technology utilizes torsion tubes to connect the actuating mechanism with the remote latches; consequently, the current technology remote latches include some sort of complex over-center mechanism that transforms this rotating movement to secure the remote latches to the mounting sub-structure. These remote latches are consequently loud when operated. Additionally, these torsion tubes have a reduced efficiency if and when the distance between the actuating mechanism and the remote latches increase. This increases the time needed to assemble and set up the system during the installation of it.

It is desirable to have a bin latch mechanism with simplicity of operation and installation.

The described invention transfers rotation into push/pull action in the actuating mechanism, and utilizes the connecting members as push/pull rods. Consequently, the connecting members have a reduced size and weight, and are not subject to mechanical properties variations if/when their length increase. Additionally, the remote latches are a combination of a few components that interlock with each other utilizing this push/pull motion. A safety device is included on each remote latch to prevent losing of the system when the remote latches are disengaged. Additionally, an emergency release mechanism is included in the remote latches to override the overall mechanism in case of sub-structure damage for example.

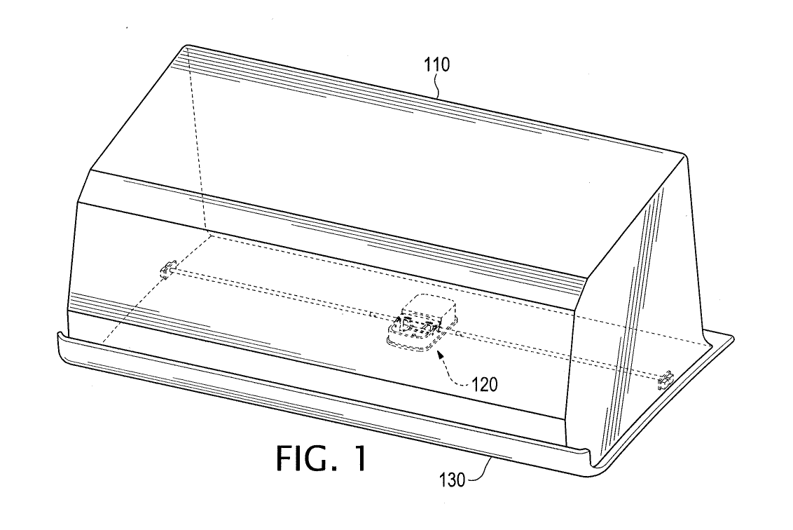

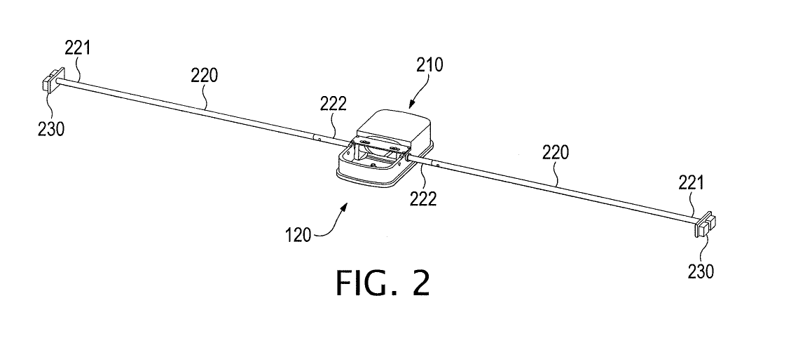

FIG. 1 shows a bin latch system 120 installed in a storage bin. The storage bin comprises a top section 110 and a base board 130 pivotably engaged to the top section for open/close operation. The bin latch system 120, installed on the base board, comprises a latch actuator 210, remote latch(s) 230 and latch rod(s) 220 as shown in FIG. 2. Each latch rod 220 has a distal end 221 coupled to a remote latch 230 and a proximal end 222 coupled to the latch actuator 210. Each remote latch 230 couples to a connecting member installed on the top section 110. The latch actuator 210 is configured to control engagement/disengagement between the remote latch and the connecting member such that the base board 130 may pivotably open or remain closed. Although the bin latch system 120 is installed on the base board as shown in FIG. 1, one of ordinary skill in the art may understand the bin latch system 120 may be adapted to install in storage bins opening from top, side, or with other configurations.

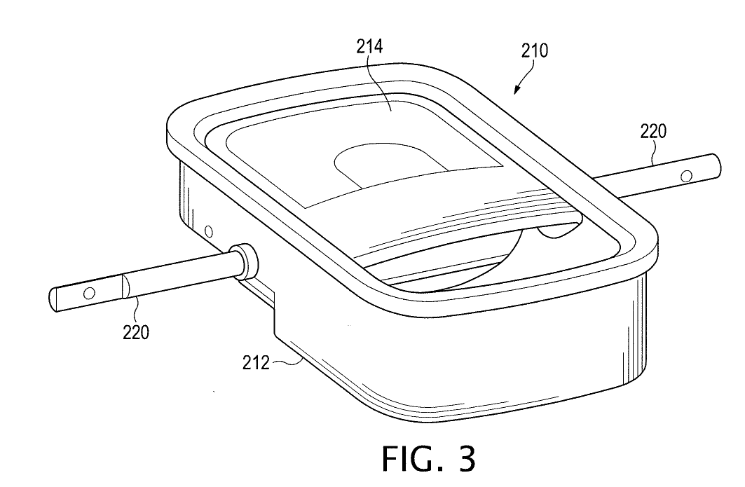

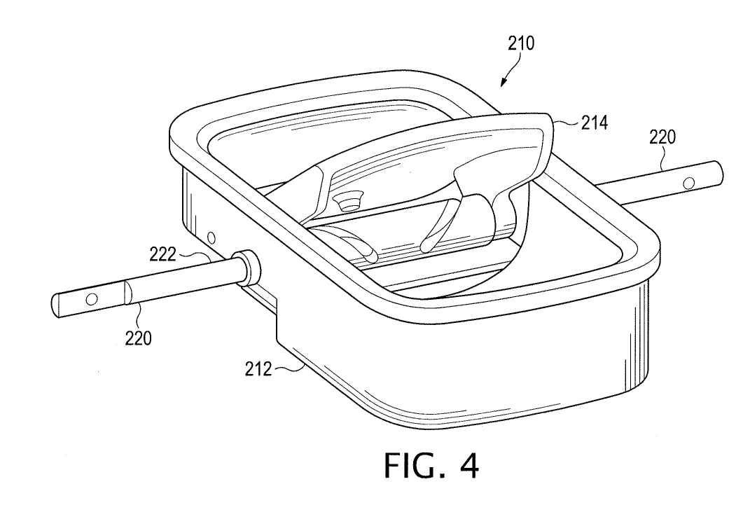

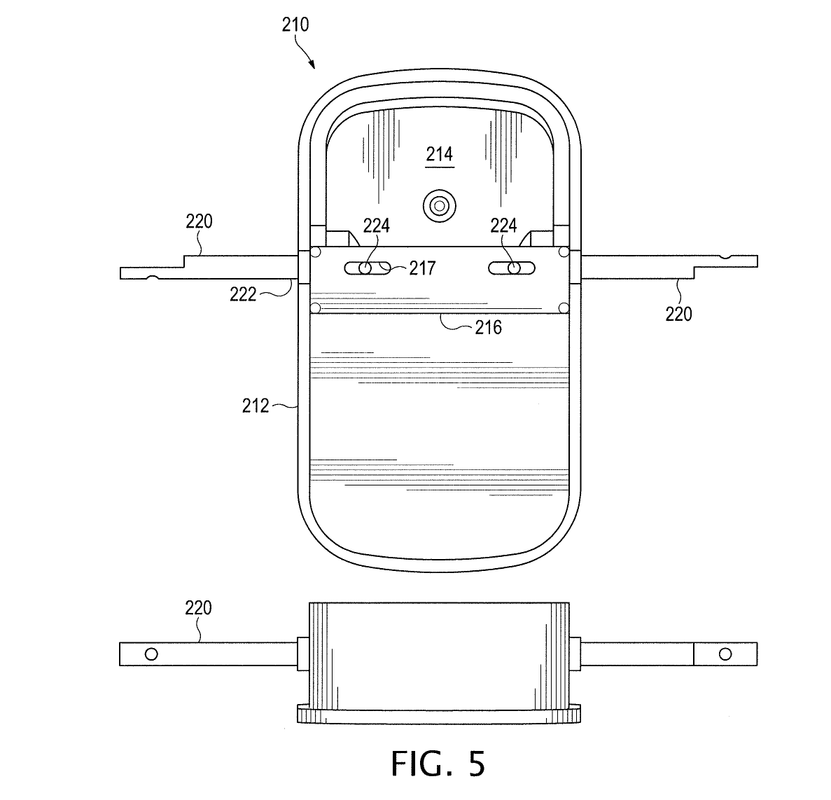

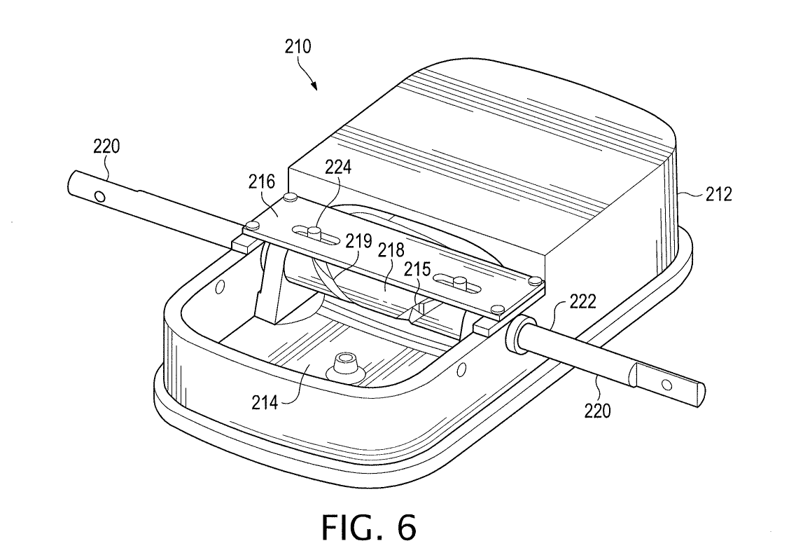

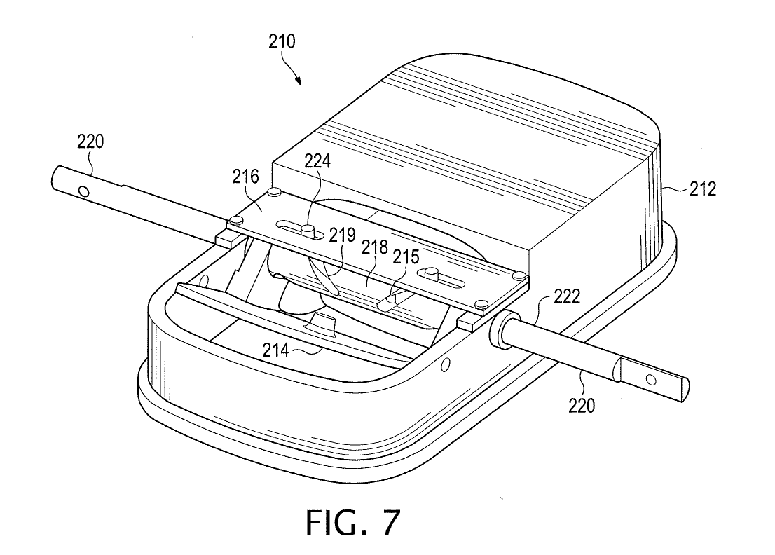

FIG. 3 and FIG. 4 show the latch actuator 210 in a closed position and an open position respectively viewed from a human interface (or an actuator interface, a handle) 214. FIG. 5 shows a top view and a front view of the actuator of the bin latch. FIG. 6 and FIG. 7 show a component view of the actuator of the bin latch in a closed position and an open position respectively.

As shown in the above figures, the latch actuator 210 comprises an actuator housing 212 rotationally securing, either directly or through an associated structure, a cylindrical sleeve (or a helix spindle) 218. The cylindrical sleeve 218 has a pair of mirror image slots 219, which are preferably helical slots or pseudo-helical slots. The sleeve 218 is rotationally retained by the actuator housing, either directly or through an associated structure. An actuator interface 214, preferably in the form of a lever arm, is pivotally mounted to the actuator housing 212, adjacent to the sleeve, and is operatively linked to the sleeve 218 to cause bi-directional rotation of the sleeve 218 during reciprocation of the actuator interface 214. Alternatively, the actuator interface may be directly mounted to or extends from the sleeve.

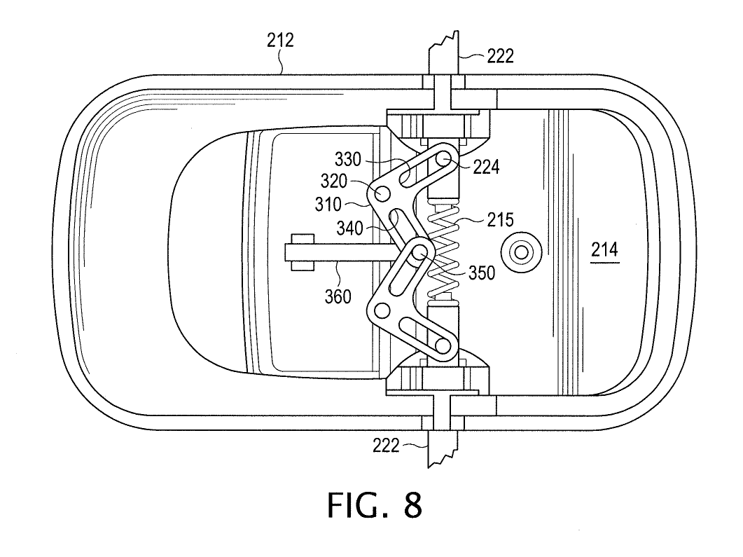

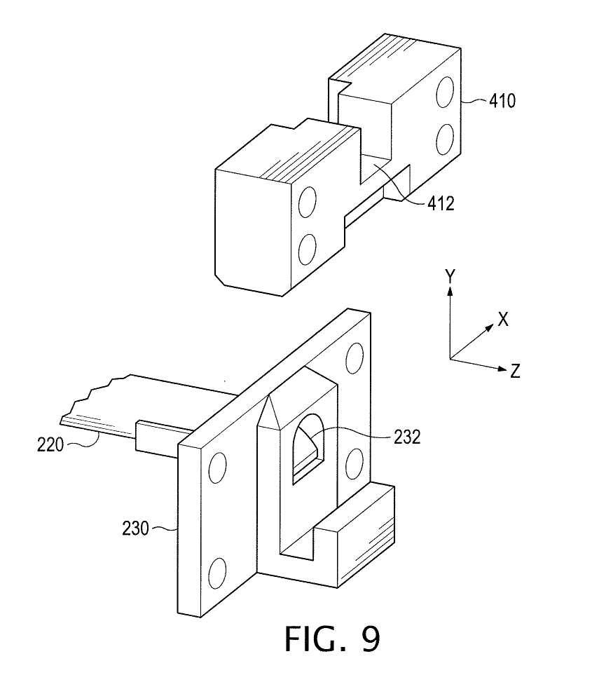

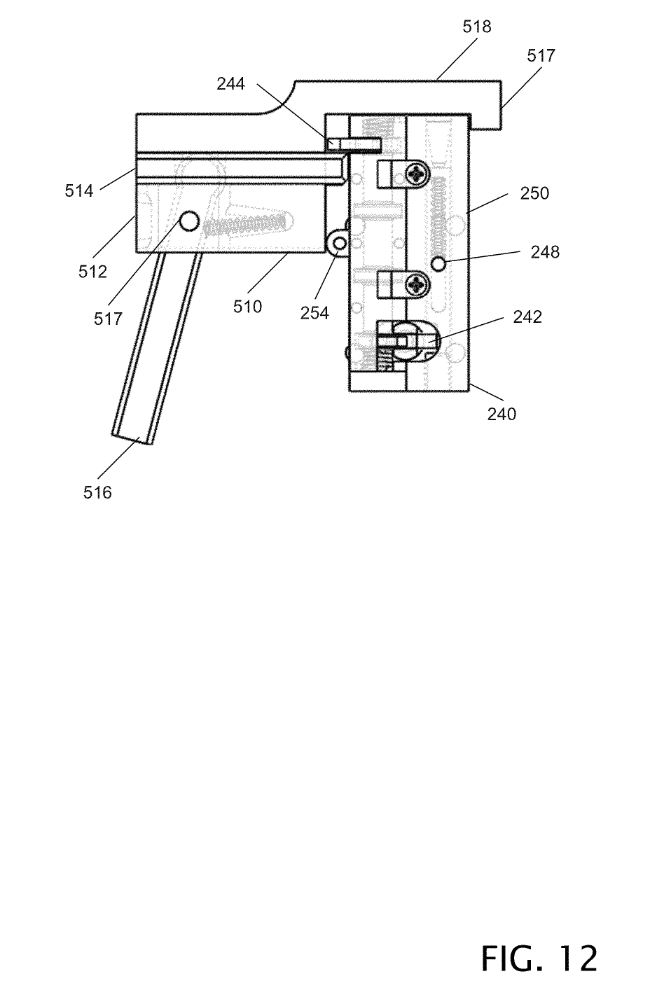

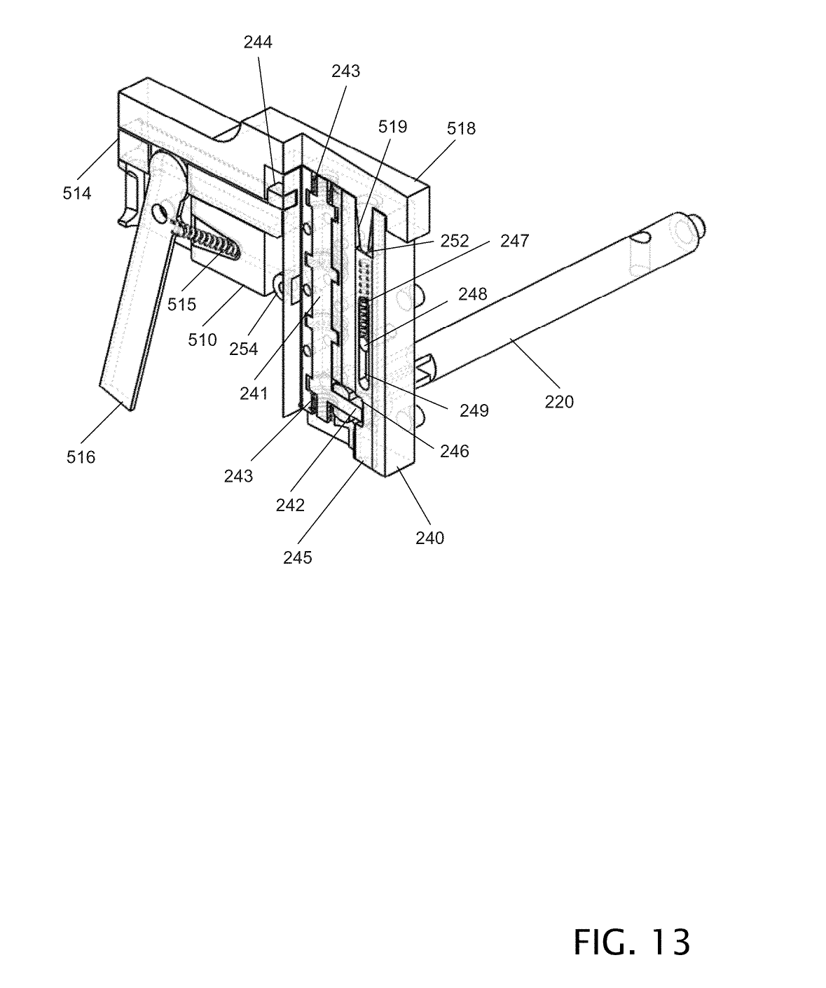

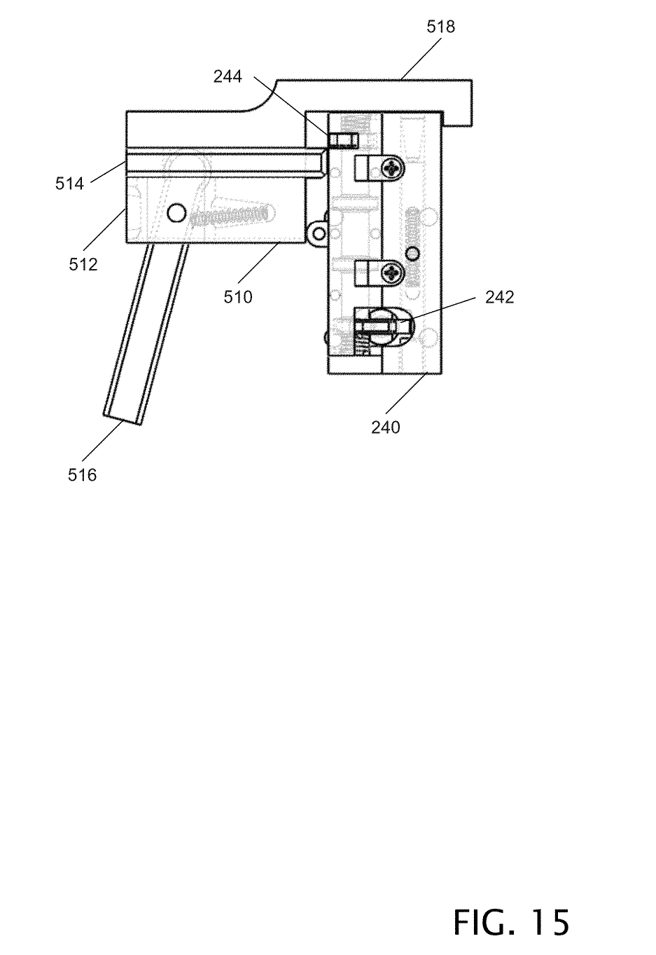

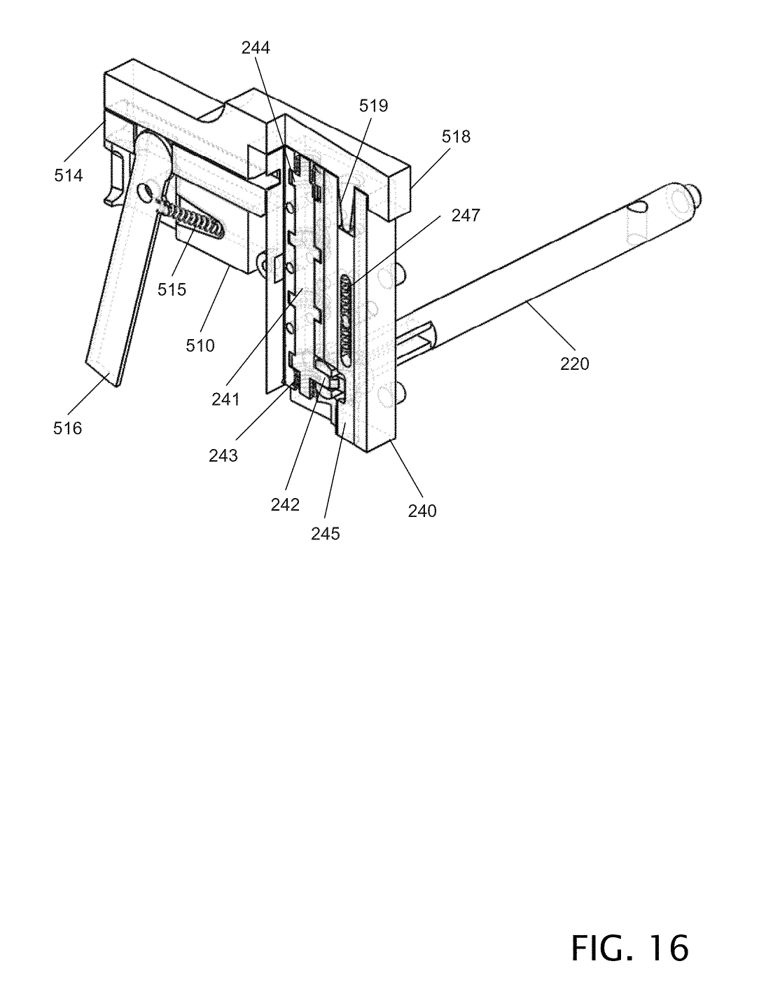

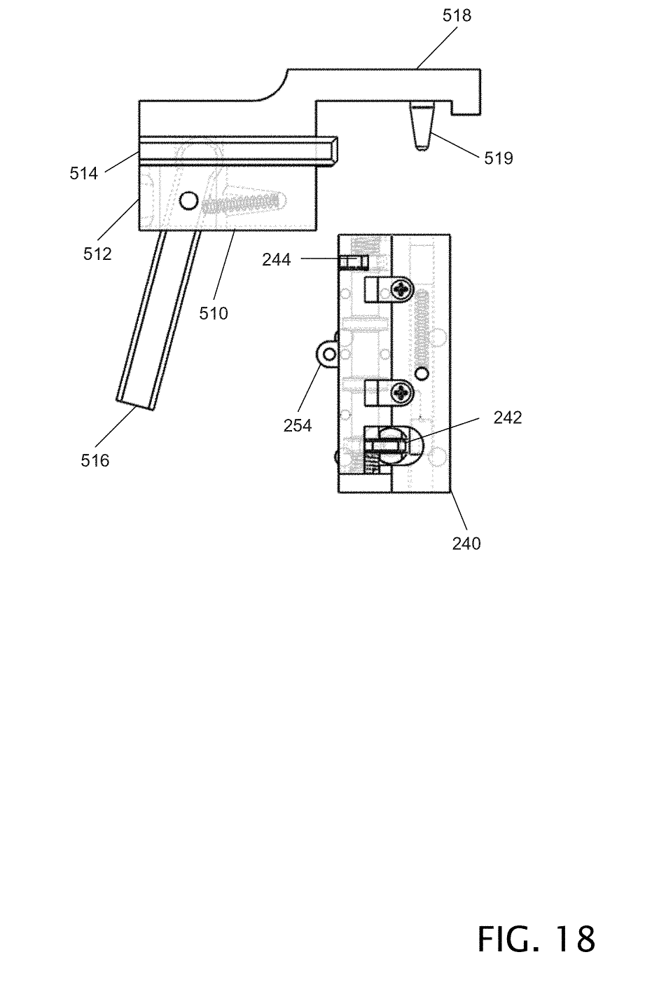

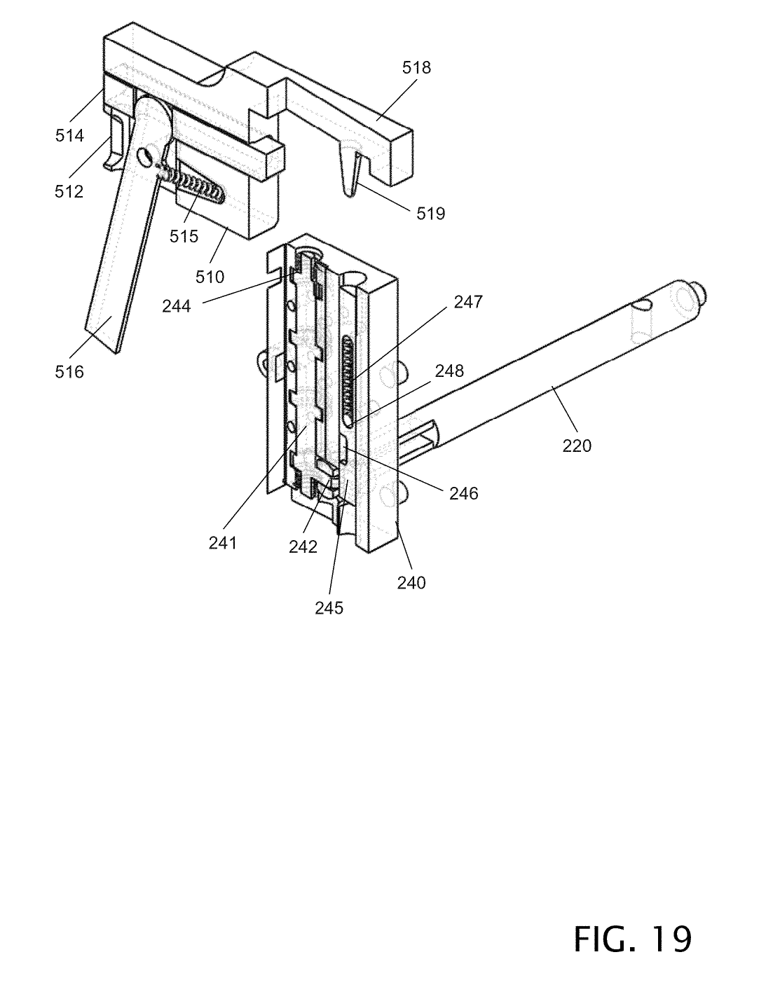

Linked to the sleeve are a pair of latch rods 220, each having a proximal portion terminating at a proximal end and a distal portion terminating at a distal end, wherein each latch rod end and at least part of each latch rod proximal portion is disposed within the sleeve. Each latch rod 220 also has a protrusion (or a control pin) 222 sized to fit within the helical slot 219. The protrusion 222 extends from each latch rod proximal portion and into a corresponding helical slot of the sleeve. The protrusion 222 is also slidably confined within a groove 217 of a cover control plate 216 attached to the actuator housing 212. Preferably a biasing member 215 is located axially between the proximal ends of the latch rods to create a distally directed vectored force in each latch rod (i.e., the latch rods are biased to extend from the latch housing towards their respective distal ends). The biasing member 215 may be a compression spring (as shown in FIG. 8), which is compressed when the acutator interface is in closed position. When the actuator interface 214 is pivotably rotated by a user, the sleeve 218 also rotates to cause the control pin 222 sliding along the helical slot 219 and also sliding in a retracted direction within the control groove 217 of a cover control plate 216. Such a retracted sliding causes a retraction movement of the latch rods 220. The distal ends of the latch rods include a strike member (or, as will be described later in FIGS. 9-20, a connection interface).

FIG. 8 shows an alternative embodiment of the actuator. Compared to the actuator shown in FIGS. 4-7, the actuator in FIG. 8 incorporates a pair of connection rods 310, each of which is attached to the actuator housing 212 on a pivot 320. The connection rod 310 has a first groove 330 near one end and a second groove 340 near the second end. Preferably, the connection rod 310 has a general L-shape with the first groove perpendicular to the second groove 340. The protrusion 222 of each latch rod 220 is slidably confined within a corresponding first groove 330. The second groove 340 of both connection rods 310 are connected by a connection pin 350, which is also coupled to the actuator interface 214 via a connection bar 360. The connection pin 350 is slidable in the second groove of both connection rods. Similar to the actuator shown in FIG. 6 and FIG. 6, a biasing member 215 (such as a compression spring) is located axially between the proximal ends of the latch rods 220 to create a vectored force in each latch rod (i.e., the latch rods are biased to extend from the latch housing towards their respective distal ends). When the actuator interface 214 pivotably rotates, it drags the connection pin 350 to pivotably rotate both connection rods 310 around each pivot 320. Such rotation of the connection rods causes the protrusion 222 of each latch rod 220 retracted sliding further into the actuator housing and thus compressing the biasing member 215 further. Eventually, the retracted sliding of the latch rod 220 causes disengaging movement of the remote latches, which will be described hereinafter.

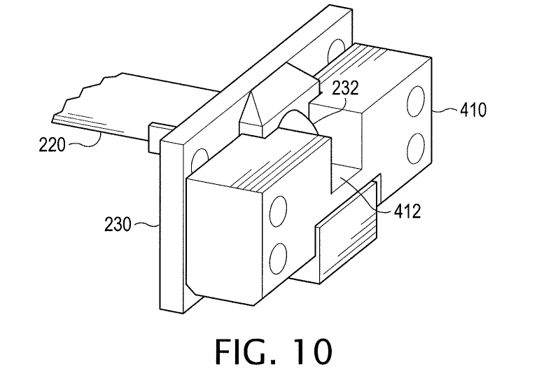

FIG. 9 and FIG. 10 show a first exemplary remote latch in a disengaged position and closed position respectively. A remote latch 230 with a strike member 232 is disposed at the distal end of the latch rod 220. The strike member 232 may be pushed or pulled by the latch rod 220. The remote latch 230 is configured to engage or disengage with a mounting substructure 410 installed to a top section of a bin storage (not shown in FIGS. 9-10). The substructure 410 has a striking area (such as a dent) 412 to receive the strike member 232 when the remote latch 230 and substructure 410 are engaged. The strike member 232 extends from remote latch 230 to prevent the substructure 410 from being disengaged unless the latch actuator operates to retract the strike member 232. In some embodiments, the strike member 232 has a tilted contact surface such that, during the engaging process, the substructure 410 may push the strike member 232 away before the striking area 412 reaches an engagement position to receive the strike member 232.

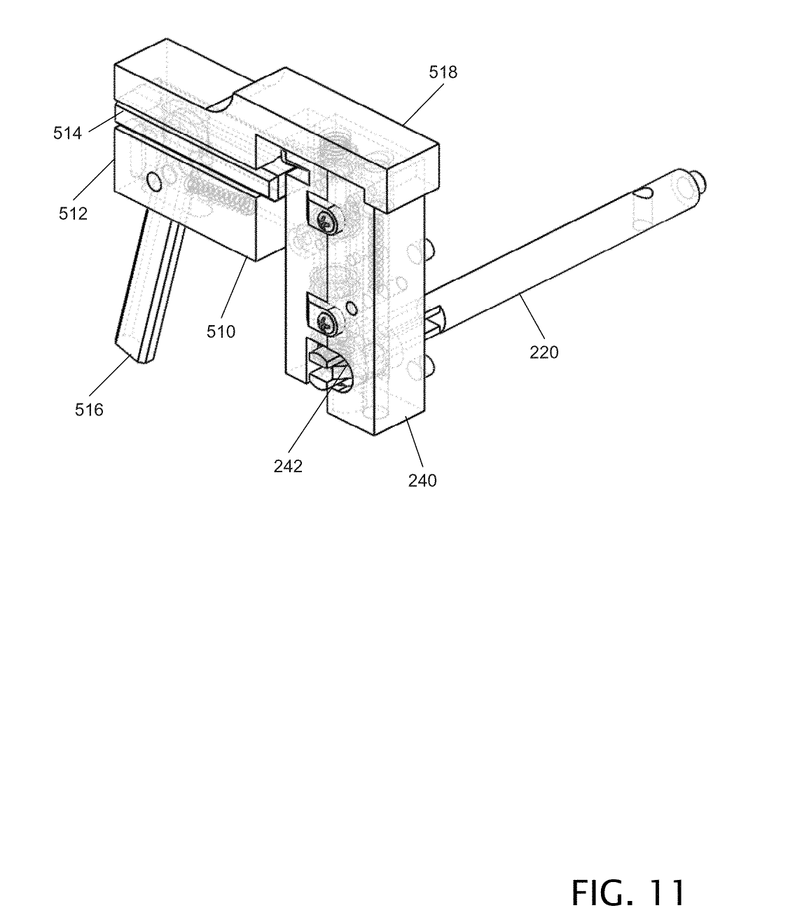

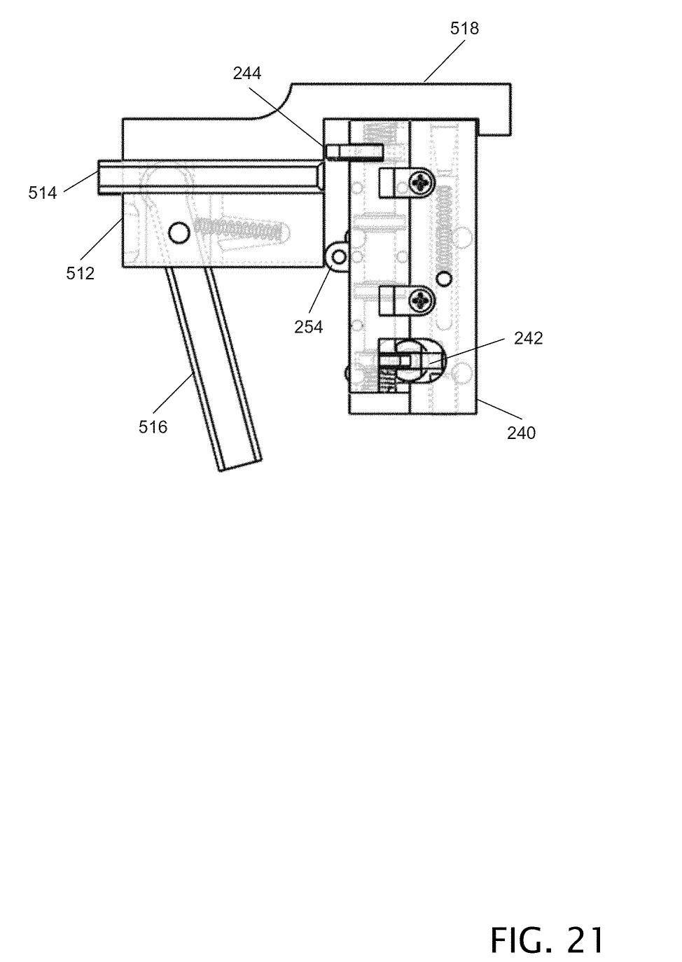

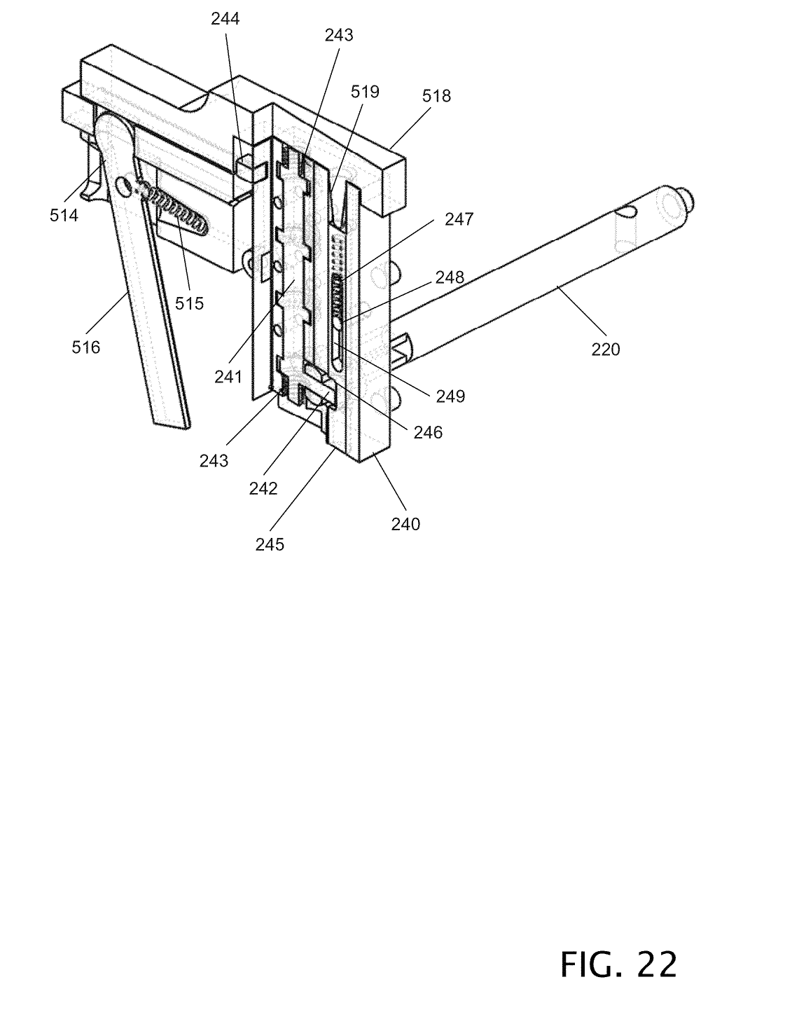

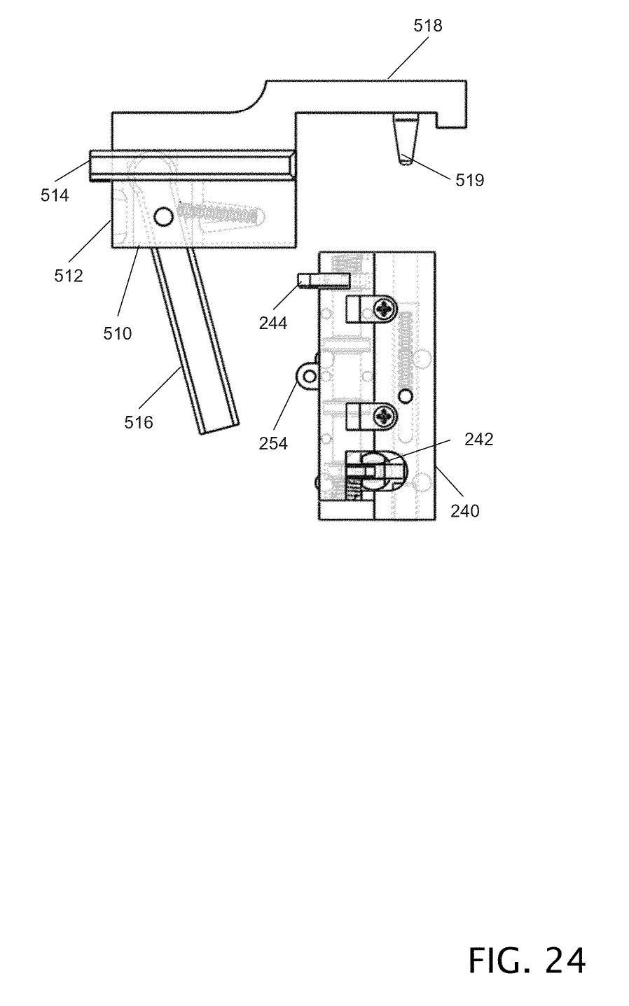

The remote latch shown in FIGS. 9-10 is simple but has one issue, when the latch actuator malfunctions, the strike member 232 may not able to retract and consequently, the substructure 410 will be able to open. To address this issue, an alternative embodiment of remote latch with corresponding substructure is disclosed in FIGS. 11-24.

FIGS. 11-13 show a prospective view, a front view, and a sectional view of a second exemplary remote latch with corresponding substructure in a closed position respectively.

The remote latch 240 has a latch housing 250 and a rotatable spindle 241 installed within the latch housing 250. The spindle 241 has a connecting tab 242 connected to the latch rod 220 and a remote latch engaging tab 244 functioning as a striking member to engage a substructure 510.

The latch rod 220 connects to a rod connecting tab 242. When the latch rod 220 retracts, it drags the rod connecting tab 242 to rotate the spindle 241 from a closed position to an open position, wherein the remote latch engaging tab 244 extends out of the latch housing 250 in the closed position and withdraws within the latch housing 250 in the open position. In some embodiments, the spindle 241 couples to a torsion spring 243, which biases the spindle 241 toward the closed position.

The substructure 510 has a substructure housing 512 and an engagement bar 514 disposed within the housing. The engagement bar 514 extrudes out of the substructure housing 512 by default. When the substructure 510 engages with the remote latch 240, the remote latch engaging tab 244 extends out of the latch housing 250 and prevents the engagement bar 514 from any disengagement movement.

In some embodiments, the substructure housing 512 further integrates an extended arm 518 and a latch interlock release pin 519 protruded from the extended arm 518. When the substructure 510 engages with the remote latch 240, the latch interlock release pin 519 resides within an aperture 252 of the latch housing 250. Such arrangement ensures that when the substructure 510 engages with the remote latch 240, they are also interlocked with each other to provide enhanced engagement robustness.

In some embodiments, the extended arm 518 has a protruded distal end 517, which also interlocks to the latch housing 250 when the substructure 510 engages with the remote latch 240. The protruded distal end 517 or the latch interlock release pin 519 may operate individually or in combination to implement the interlock function for enhanced engagement robustness.

In some embodiments, the remote latch 240 further comprises a remote latch lock bar 245 disposed within the aperture 252 of the latch housing 250. The remote latch lock bar 245 has an indent 246 aligned with the rod connecting tab 242 when the spindle 241 is in the closed position. The remote latch lock bar 245 further comprises a bar groove 249 and a remote latch lock spring 247 disposed within the bar groove 249. When the spindle 241 is in the closed position, the remote latch lock spring 247 is compressed against a remote latch lock pin 248, which is securely attached to the latch housing 250.

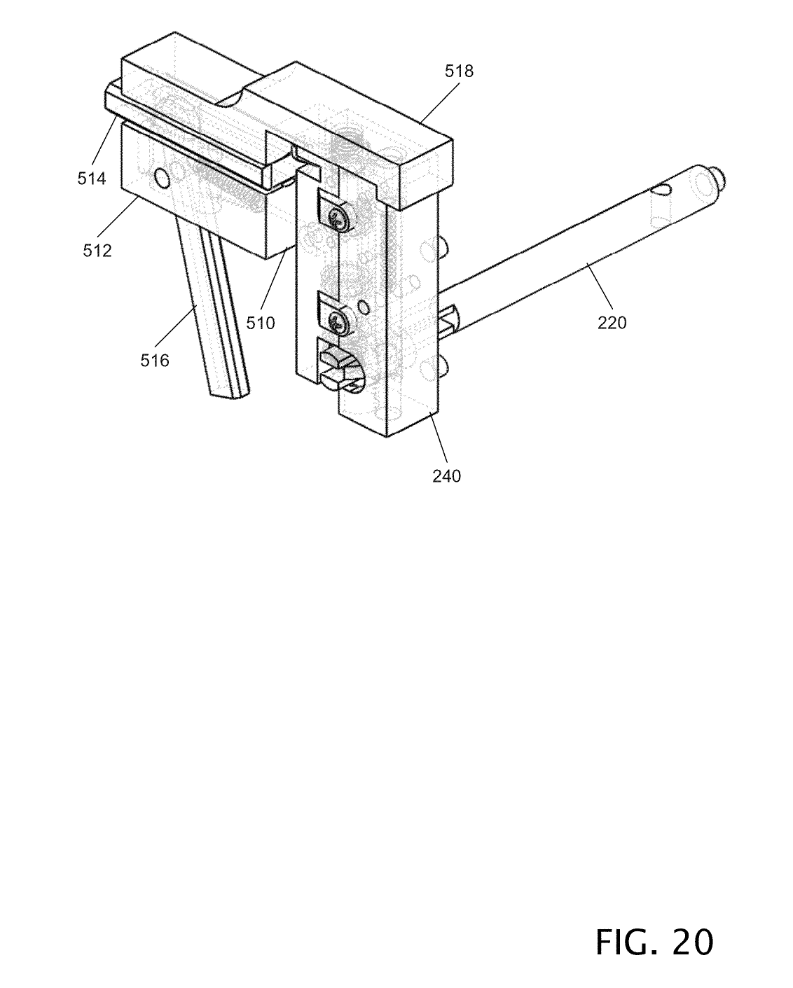

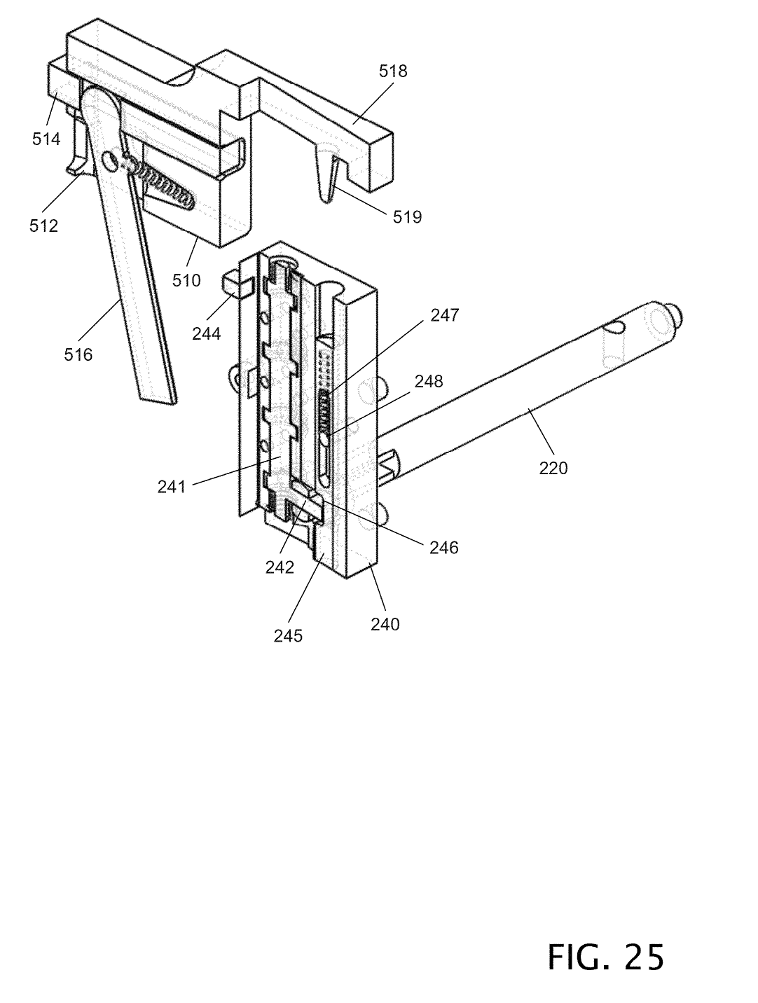

In some embodiments, the substructure 510 further comprises a latch safety level 516 pivotably attached to the substructure housing 512 and coupled to the engagement bar 514. The latch safety level 516 is biased by a compressed spring 515, to set the engagement bar 514 projected out from the substructure housing 512. The latch safety level 516 may be pivotably moved under emergency situation (such as when the latch actuator does not operate, etc.) to slide the engagement bar 514 back into the substructure housing 512 such that the substructure 510 may be disengaged from the remote latch 240 even without the retraction movement of the latch rod 220. The details of the operation of the latch safety level 516 will be disclosed later with respect to FIGS. 20-25.

In some embodiments, the remote latch 240 further incorporates a roller 254 attached to the latch housing 250. The roller 254 may be disposed on the same side as the remote latch engaging tab 244 to provide additional structure support for the alignment between the remote latch 240 and the substructure 510. The roller 254 also smooths the engagement and disengagement movement between the remote latch 240 and the substructure 510.

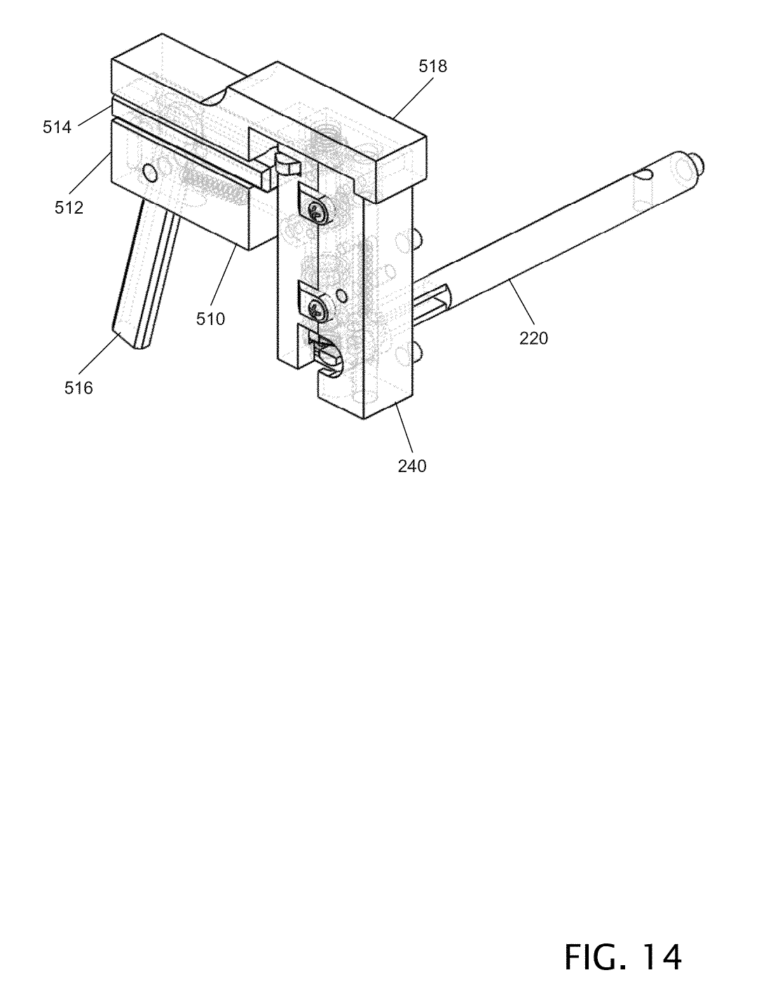

FIGS. 14-16 show a prospective view, a front view, and a sectional view of the remote latch 240 with corresponding substructure in an open position. When the latch rod 220 retracts (caused by the latch actuator 210 as disclosed with respect to FIGS. 4-8), it drags the rod connecting tab 242 to rotate the spindle 241 from a closed position to an open position, wherein the remote latch engaging tab 244 extends out of the latch housing 250 in the closed position and withdraws within the latch housing 250 in the open position. With the remote latch engaging tab 244 withdrawn, the substructure is ready to be disengaged from the remote latch 240.

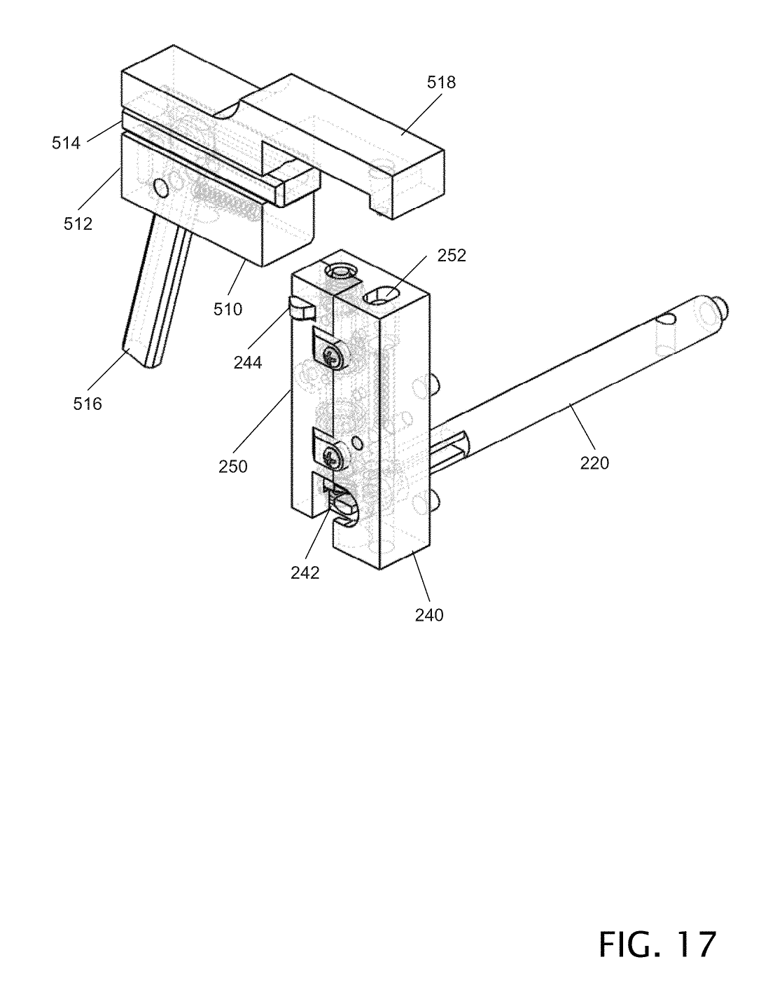

FIGS. 17-19 show a prospective view, a front view, and a sectional view of the remote latch 240 being disengaged from the substructure 510. When the remote latch engaging tab 244 withdraws, the rod connecting tab 242 also rotates out from the indent 246 of the remote latch lock bar 245 simultaneously. The remote latch lock spring 247 pushes the remote latch lock bar 245 to slide upward along the aperture 252 to release the kinetic energy stored within the remote latch lock spring 247. Such a push may also facilitate the process of disengagement between the remote latch 240 and the substructure 510.

Once the remote latch lock bar 245 slides upward, the indent 246 is not aligned to the rod connecting tab 242. Consequently, the spindle 241 is locked in the open position unless the substructure 510 re-engages to the remote latch 240 to push the remote latch lock bar 245 downward by the latch interlock release pin 519. Such a configuration is advantageous to keep the remote latch 240 staying in the disengaged state once the substructure 510 detaches from the remote latch 240. Furthermore, during the engaging process, the remote latch lock spring 247 also provide a “soft-close” mechanism to prevent abrupt mechanic stresses.

FIGS. 20-22 show a prospective view, a front view, and a sectional view of the remote latch 240 and the substructure 510 in a released position under emergency operation. Under normal operation, the latch safety level 516 is biased by a compressed spring 515, to set the engagement bar 514 projected out from the substructure housing 512. However, in an emergency situation (such as when the latch actuator does not operate or the latch rod is broken, etc.), the latch safety level 516 may be used to provide an alternative way to disengage the substructure 510 from the remote latch 240. During emergency operation, the latch safety level 516 may be pivotably moved to slide the engagement bar 514 backward within the substructure housing 512 such that the remote latch engaging tab 244 is no longer an obstacle for the disengaging movement of substructure 510, even though the remote latch engaging tab 244 still extends out of the latch housing 250.

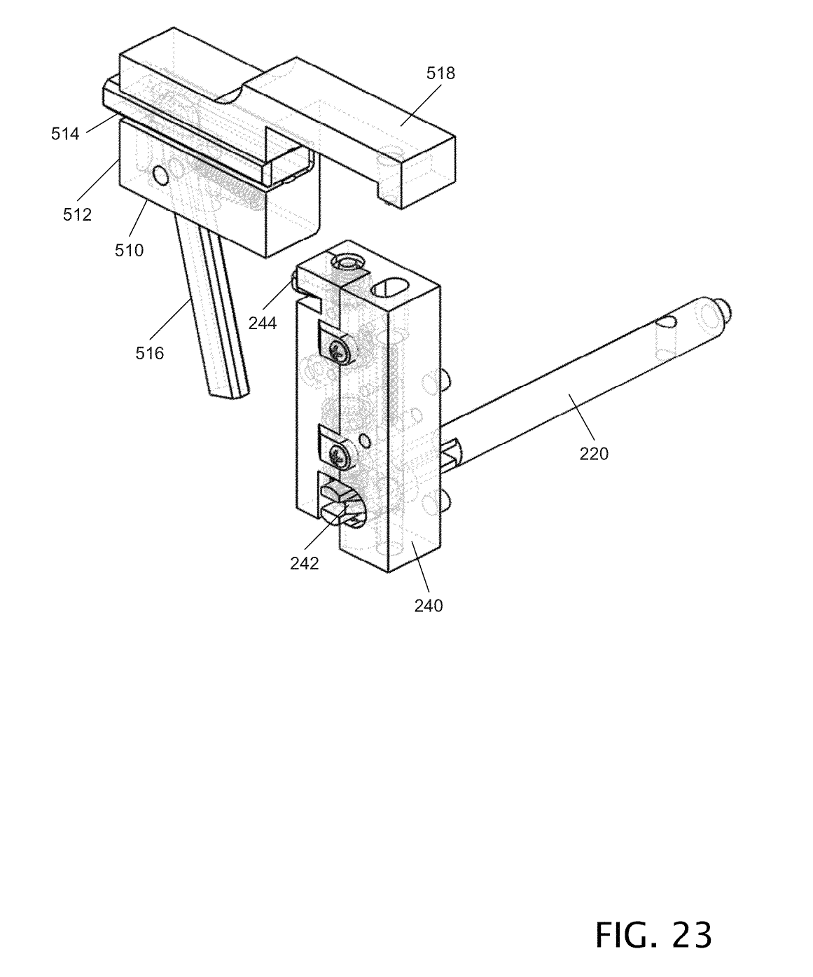

FIGS. 23-25 show a prospective view, a front view, and a sectional view of the remote latch 240 and the substructure 510 being disengaged under emergency operation. Compared to the disengagement under normal operation as shown in FIGS. 17-19, the disengagement under emergency operation differs in two aspects. First, the remote latch engaging tab 244 still extends out of the latch housing 250. Second, the indent 246 of the remote latch lock bar 245 still aligns to the rod connecting tab 242. Such configurations ensure that the remote latch stays in the closed position even the substructure 510 disengages from it already. When the substructure 510 engages again, the remote latch 240 does not need to reset to the closed position again.

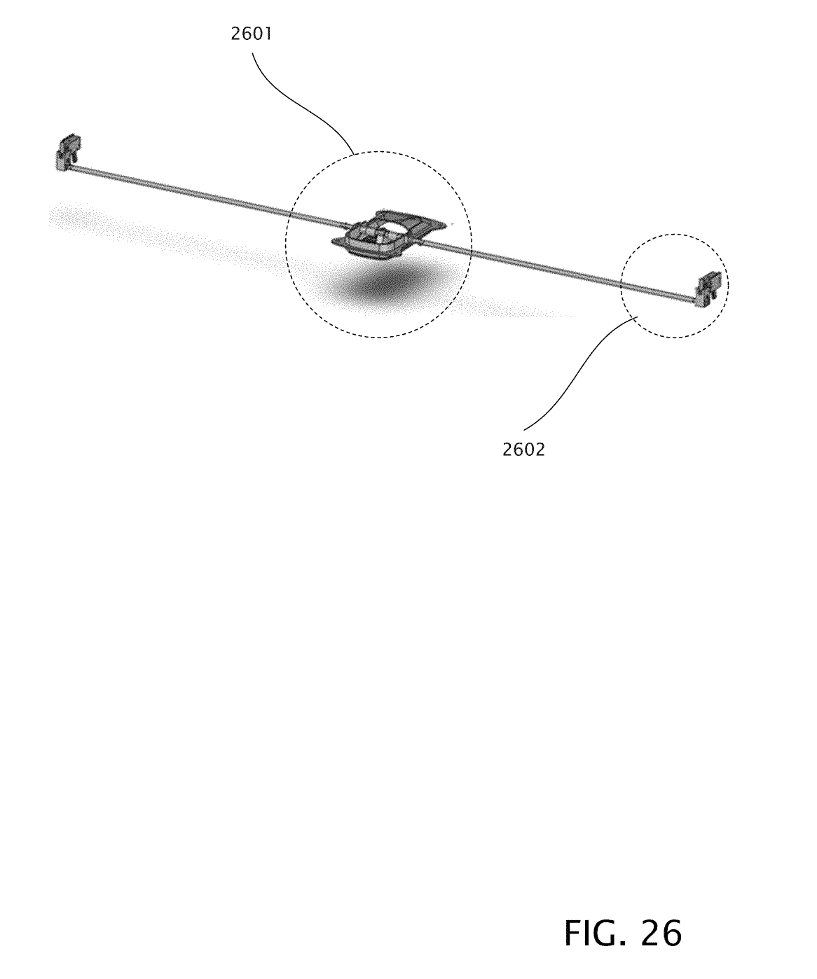

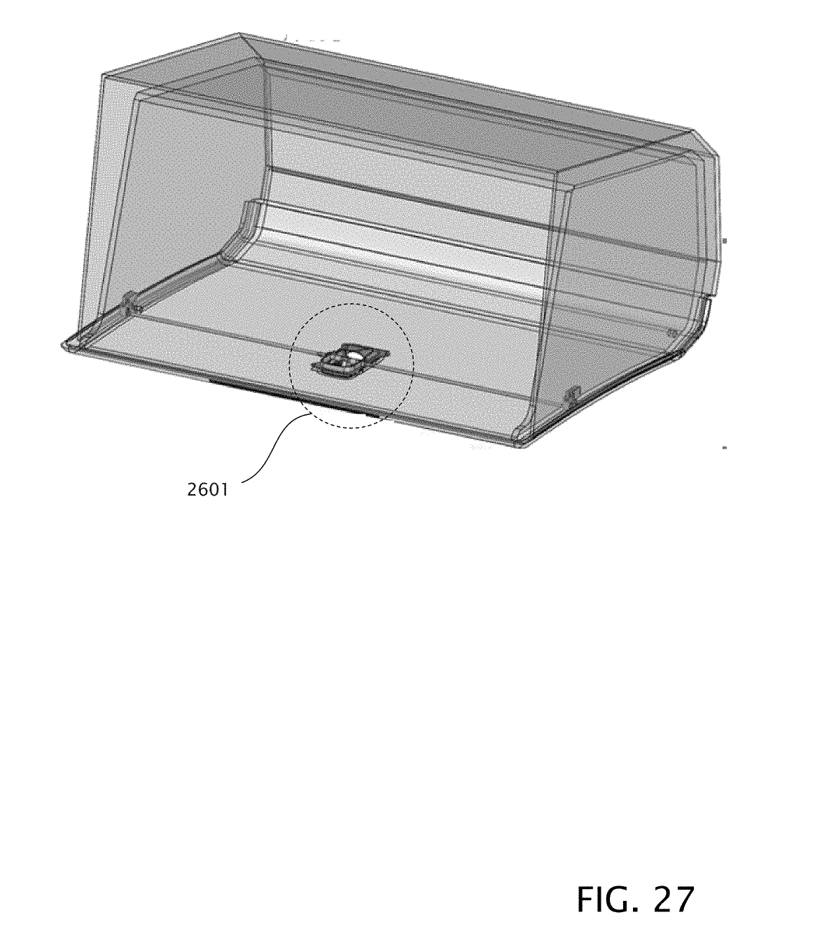

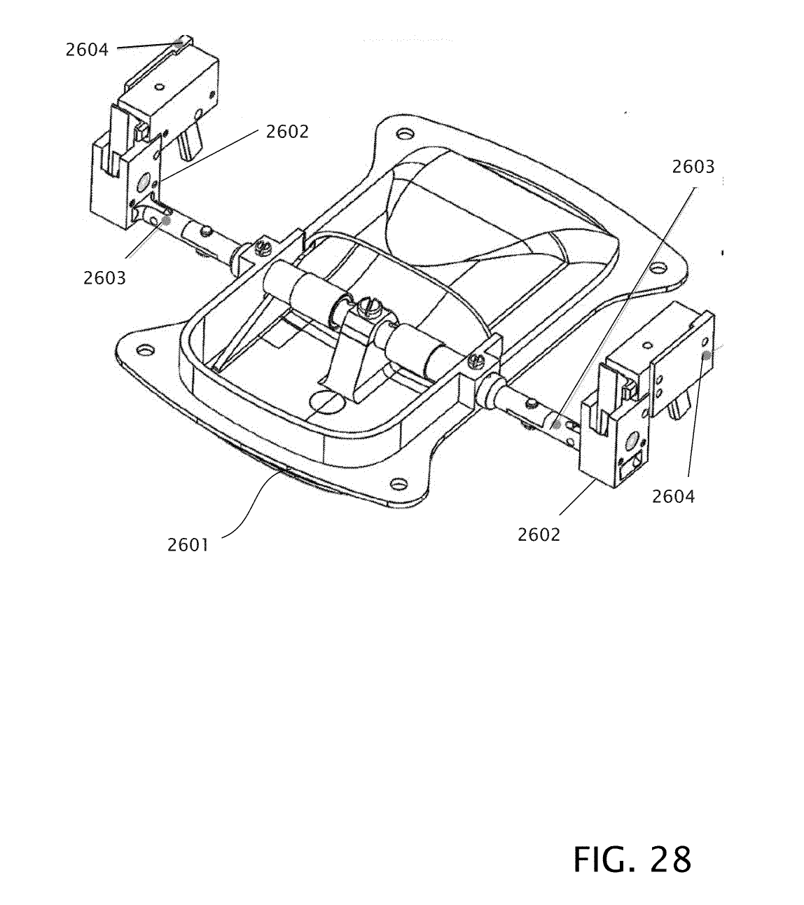

FIG. 26 shows a second embodiment of a bin latch system including an actuator 2601 with interchangeable end pieces, or latches 2602. FIG. 27 shows the bin latch system including the actuator 2601 and latches 2602 installed in a storage bin. FIG. 28 shows a close-up view of the actuator 2601, the remote latches 2602, latch rod 2603 coupled between the actuator 2601 and the remote latch 2602, and substructures 2604 capable of engaging to corresponding remote latch 2602.

The second embodiment of a bin latch system is directed to multiple contact point latch actuators; latch assemblies comprising said latch actuators in addition to latch strikes and latch units, the latter of which are preferably interlocking to create a constrained mechanical fit between the components thereof, said actuators and latch assemblies being particularly adapted for hinged structures such as stowage bins; and methods for operating latch actuators and latch assemblies, as well as for securing and un-securing hinged structures comprising latch assemblies.

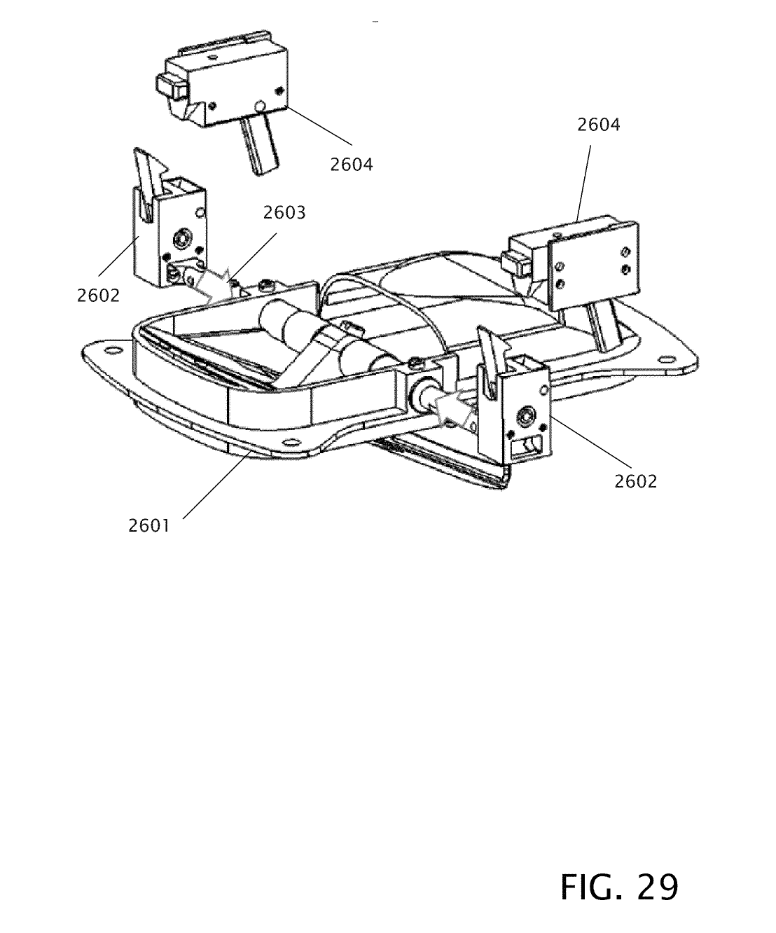

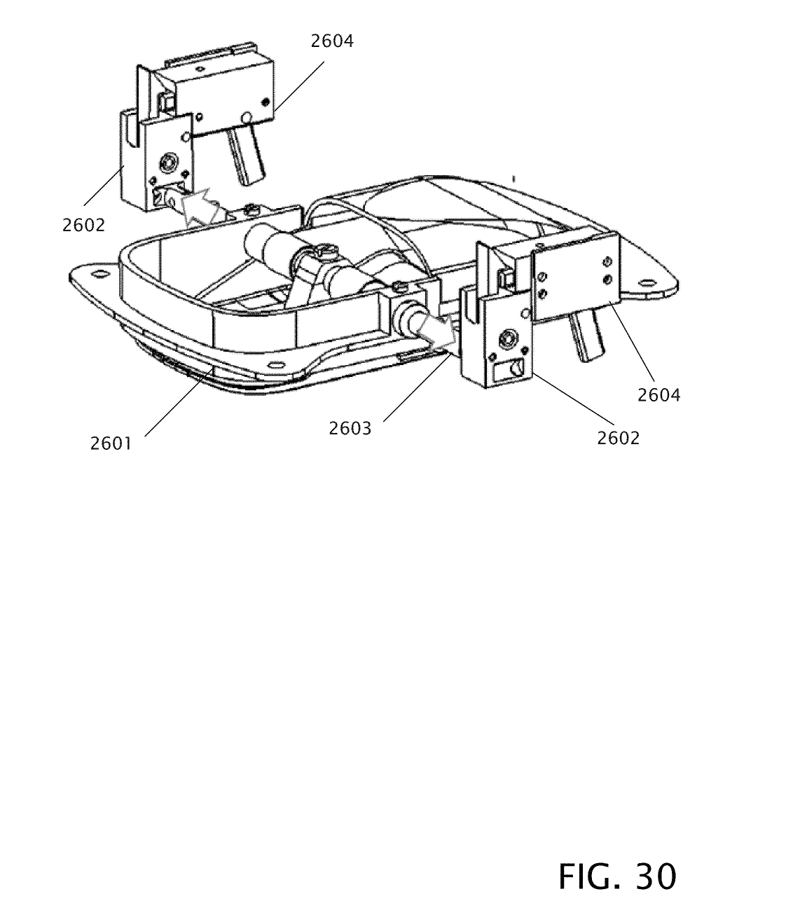

FIGS. 29 and 30 shows an open and closed position of the second embodiment of a bin latch system. When the actuator 2601 operates to pull the latch rod 2603 or cause the latch rod retract toward the actuator 2601 (as shown in FIG. 29), the latch 2602 disengages with the corresponding substructure 2604. On the contrary, when the actuator 2601 operates to push the latch rod 2603 or cause the latch rod extend toward the latch 2602 (as shown in FIG. 30), the latch 2602 engages with the corresponding substructure 2604. The latch rods 2603 shown in FIGS. 29 and 30 are just for schematic view and may have length different from identified in the Figs.

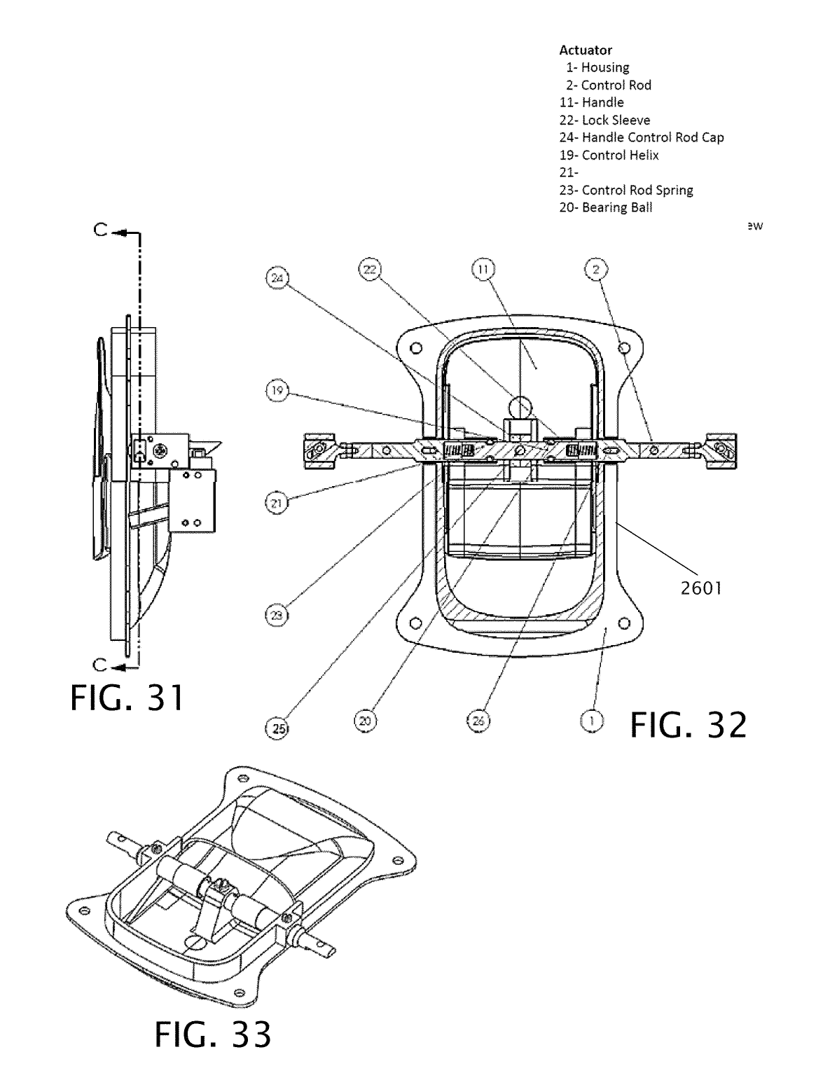

FIGS. 31-33 show assembly and nomenclature of the actuator 2601. The actuator handle 11 is coupled to a helix drive (control helix 19), which transforms the rotational movement of the handle 11 into axial movement via helix grooves into bearing balls 20 that are coupled with control rods 2 (also referred as the latch rod 2603). As these control rods 2 can only move axially (rotation controlled by slide screw 26), they react to the input of the bearing balls, which in turn, are riding on the Control Rod helix groves.

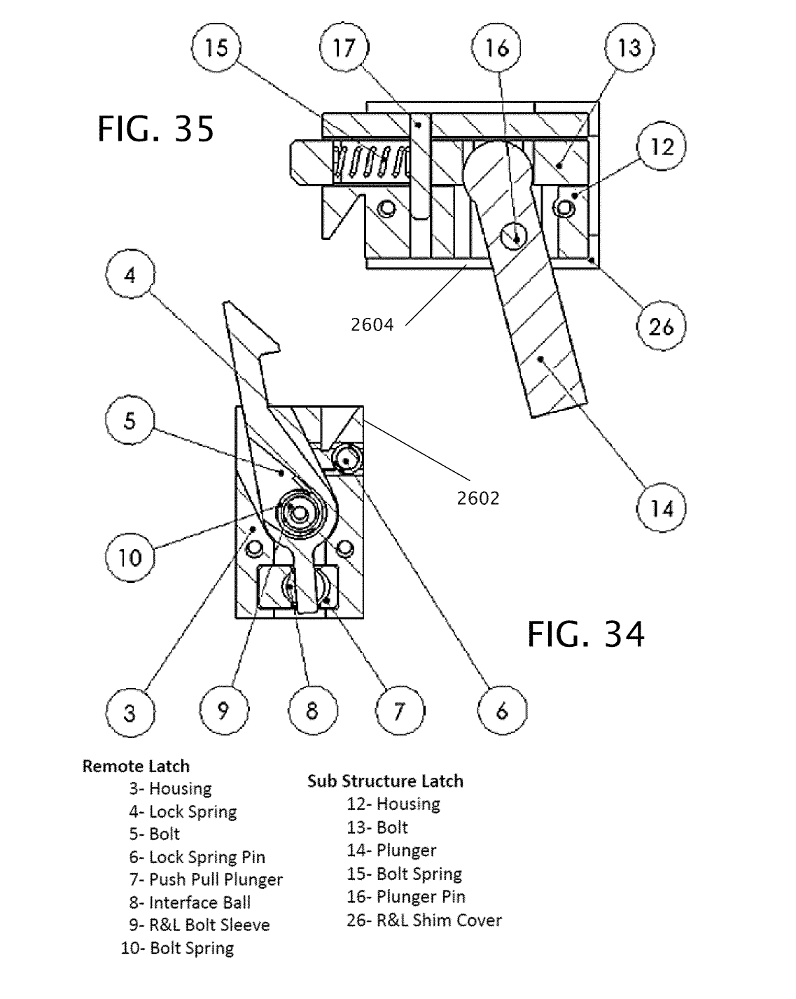

FIGS. 34-35 shows assembly and nomenclature of the latch and substructure. The control rods 2 (also referred as the latch rod 2603) are connected to remote latches 2602. These remote latches receive the control rod motion through the push pull plunger 7. These push pull plungers include an angles slot in them so they can transform the axial movement input into a rotational movement via the interface ball 8 into the bolt 5 which pivots around the R&L Bolt Sleeve 9. Once the remote latch is open, the sub structure latch bolt 13 is free, and the sub structure 2604 is then disengaged from the remote latch 2602. Once this occurs, the remote latch 2602 lock spring 4 moves to rest in its locked position preventing the remote latch bolt 5 from returning to its closed position. As this occurs at both ends of the latch system, this feature makes the system binary in terms of positions. This is visible to the operator as the handle is consequently locked in its open position. Only when the sub structure 2604 is back into its engaged position, the remote latch lock spring 4 is pushed away and the remote latch bolt 5 is spring loaded to its locked position by the remote latch bolt spring 10. Once this occurs, the actuator handle (11 in FIG. 31) is able to rotate to its closed position assisted as well by the control rod springs 23 (in FIG. 31).

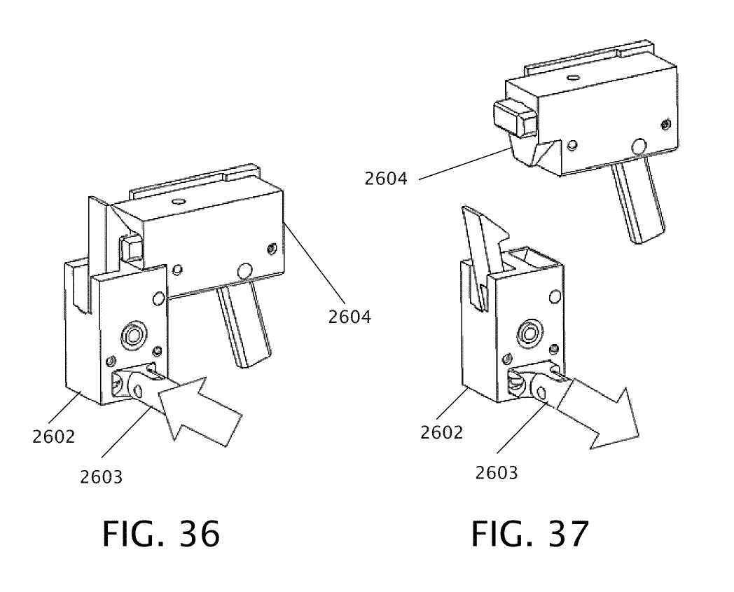

FIGS. 36-37 show a close-up view of the open and close position of the latch. When the actuator 2601 operates to pull the latch rod 2603 or cause the latch rod retract toward the actuator 2601 (as shown in FIG. 29), the latch 2602 disengages with the corresponding substructure 2604. On the contrary, when the actuator 2601 operates to push the latch rod 2603 or cause the latch rod extend toward the latch 2602 (as shown in FIG. 30), the latch 2602 engages with the corresponding substructure 2604.

Those skilled in the art will realize that the bin latch can be constructed with various configurations. For example a latch actuator or a remote latch may comprise different combination of components other than disclosed in the aforementioned embodiments. Those skilled in the art will also realize that the bin latch can be constructed with various modifications. For example, the bin latch system may be configured with a latch actuator controlling only one remote latch using one latch rod with minor modification of the latch actuator.

Those skilled in the art will also realize that a bin latch may further incorporate different components. The foregoing description of the invention has been described for purposes of clarity and understanding. Various modifications may be implemented within the scope and equivalence of the appended claims.

1. A bin latch system comprising:
a latch actuator comprising:
an actuator housing;
a sleeve pivotably attached to the actuator housing, the sleeve having one or more slots;
an actuator interface coupled to the sleeve;
one or more latch rods coupled at a proximal end of each latch rod to the latch actuator, each latch rod having a protrusion extended from a proximal portion and fitted within a corresponding slot of the one or more slots; and
one or more remote latches with each remote latch coupled to a distal end of a corresponding latch rod;
wherein a rotation of the actuator interface causes the protrusion of each latch rod sliding within the corresponding slot to actuate a push or pull of each latch rod for the control of the one or more remote latches.

2. The bin latch system of claim 1 wherein the latch actuator further comprising a cover control plate attached to the actuator housing, the cover control plate having at least one groove, the protrusion of each latch rod being slidably confined within a corresponding groove.

3. The bin latch system of claim 1 wherein the one or more slots on the sleeve are helical slots such that when the protrusion of each latch rod slides within a corresponding helical slot, the protrusion is pushed or pulled by the corresponding helical slot.

4. The bin latch system of claim 1 wherein the one or more latch rods are biased to extend from the latch housing towards their respective distal ends.

5. The bin latch system of claim 4 wherein when the one or more latch rods are biased by a compression spring.

6. The bin latch system of claim 5 wherein the one or more latch rods comprise two latch rods, the compression spring is disposed between proximal ends of the two latch rods.

7. The bin latch system of claim 1 wherein each of the one or more remote latches comprises a strike member to be pushed or pulled by the corresponding latch rod for latch open or close control.

8. A latch system comprising:
a latch comprising;
a latch housing,
a spindle disposed within the latch housing, the spindle having a connecting tab connected to a latch rod and a latch engaging tab functioning as a striking member, the spindle being rotatable to cause the latch engaging tab extended out of the latch housing or withdrawn within the latch housing when the connecting tab is pulled or pushed by the latch rod; and
a substructure comprising:
a substructure housing;
an engagement bar attached to the substructure housing, when the substructure engages with the latch, the latch engaging tab extends out of the latch housing and prevents the engagement bar from disengagement movement.

9. The latch system of claim 8 wherein the spindle is biased by a torsion spring toward to a closed position with the latch engaging tab withdrawn within the latch housing.

10. The latch system of claim 8 wherein the engagements bar is slidable to retract into the substructure housing such that the substructure is disengageable from the latch even when the latch engaging tab extends out of the latch housing.

11. The latch system of claim 10 wherein the substructure further comprises a latch safety handle coupled to the engagement bar, when the latch safety handle is in a releases position, the latch safety handle causes the engagement bar to slidably retract into the substructure housing;

12. The latch system of claim 11 wherein the latch safety handle is biased by a compressed spring to push the engagement bar projected out from the substructure housing.

13. The latch system of claim 8 wherein the substructure housing further integrates an extended arm and a latch interlock release pin protruded from the extended arm, the latch housing further comprises an aperture, when the substructure engages with the latch, the latch interlock release pin resides within the aperture for an interlock between the substructure and the latch.

14. The latch system of claim 13 wherein the latch further comprises a latch lock bar slidable within the aperture of the latch housing, the remote latch lock bar has an indent aligned with the rod connecting tab when the spindle is in a closed position with the latch engaging tab withdrawn within the latch housing.

15. The latch system of claim 14 wherein the remote latch lock bar further comprises a bar groove and a remote latch lock spring disposed within the bar groove, when the spindle is in the closed position, the remote latch lock spring is compressed against a remote latch lock pin.

16. The latch system of claim 15 wherein when the spindle is in an open position with the rod connecting tab rotating out from the indent of the latch lock bar, the remote latch lock spring pushes the remote latch lock bar to slide upward along the aperture with the indent not aligned to the rod connecting tab, which causes the spindle being locked in the open position unless the remote latch lock bar is pushed downward by the latch interlock release pin during a re-engaging process.

17. The latch system of claim 8 wherein the latch further incorporates a roller attached to the latch housing to facilitate a smooth engagement or disengagement movement between the latch and the substructure.

18. A bin latch system comprising:
a latch actuator comprising:
an actuator housing;
a pair of connection rods, each connection rod attached to the actuator housing on a pivot, each connection rod having a first groove near one end and a second groove near an opposite end, the second grooves of the two connection rods being connected by a connection pin, the connection bin being slidable in the second groove of both connection rods;
an actuator interface coupled to the connection pin via a connection bar;
two latch rods coupled at a proximal end of each latch rod to the latch actuator, each latch rod having a protrusion slidably confined within the first groove of a corresponding connection rod; and
two remote latches with each remote latch coupled to a distal end of a corresponding latch rod;
wherein when the actuator interface rotates to drags the connection pin to pivotably rotate both connection rods around each pivot, the rotation of both connection rods causes the protrusion of each latch rod sliding inwardly into the actuator housing and thus pulls the two latch rods to open or close the two remote latches.

19. The bin latch system of claim 18 wherein the two latch rods are biased, by a compression spring disposed between proximal ends of the two latch rods, to extend from the latch housing towards their respective distal ends.

20. The bin latch system of claim 18 wherein each connection rod has a general L-shape with the first groove perpendicular to the second groove.
